(19) United States
(12) Patent Application Publication
(10) Pub. No.: US 2011/0200205 A1
(43) Pub. Date: Aug. 18, 2011

(54) SOUND PICKUP APPARATUS, PORTABLE COMMUNICATION APPARATUS, AND IMAGE PICKUP APPARATUS

(75) Inventor: Toshimichi Tokuda, Fukuoka (JP)

(73) Assignee: PANASONIC CORPORATION, Osaka (JP)

(21) Appl. No.: 12/707,319

(22) Filed: Feb. 17, 2010

(51) Int. Cl. H04R 3/00; G10L 19/02; H04N 5/76

(52) U.S. Cl. 381/92; 704/203; 348/231.4; 348/240.99; 704/E19.01

(57) ABSTRACT

A sound pickup apparatus includes: a microphone array including at least three microphones, wherein a first pair of microphones in which two of the at least three microphones are aligned on a first axis, and a second pair of microphones in which two of the at least three microphones are aligned on a second axis; a first null signal generator which outputs a first null signal based on a differential output of the first pair of microphones; a second null signal generator which outputs a second null signal based on a differential output of the second pair of microphones; and a combiner which generates a target signal based on the first null signal and the second null signal, the target signal having a directional characteristic in which the lowest sensitivity is formed in a direction to a line along which the first null surface meets the second null surface.

### BACKGROUND

1. Technical Field

The present invention relates to a sound pickup apparatus, which is incorporated in a portable communication terminal and a speech recognition terminal, capable of suppressing ambient sounds and clearly picking up the sound of a user, a portable communication apparatus and an image pickup apparatus provided with the sound pickup apparatus.

2. Background Art

There are many cases where a portable communication terminal and a speech recognition terminal are used in an environment, in which much noise exists, such as outdoors, and a lowering in communication sound quality and speech recognition performance becomes problematic due to a mixture of noise into sound signals. It is desired that a sound pickup apparatus incorporated in such a terminal has a directivity by which a beam (a direction of especially high sensitivity) is formed in the direction in which a user utters. Therefore, noise that reaches the sound pickup apparatus from the surroundings of the user is suppressed, wherein the sound of the user is intensified, and improvement in the communication sound quality and speech recognition performance can be expected. Hereinafter, it is assumed that target signals such as the sound of a user are called “target sounds”, and signals other than the above signals are called “noise”.

In recent years, a sound pickup apparatus of a microphone array system has been developed in order to achieve such a directivity, which is composed of a plurality of microphones and can obtain a desired directional characteristic by processing and combining signals output from the microphones. In comparison with a sound pickup apparatus composed of a single microphone, it may be listed, as advantages of the microphone array system, that a desired directional characteristic can be easily obtained by digital signal processing and there is little restriction in arrangement of sound holes since non-directional-type microphones can be utilized. Here, the sound hole means a hole made in the casing of a communication terminal in order to guide sound to microphones in the casing of the communication terminal.

Several types of systems have been known as signal processing to form directivity using a microphone array. As a representative system, a delay-and-sum type microphone array may be listed, which is described in Acoustic Systems and Digital Processing For Them edited by the Institute of Electronics, Information and Communication Engineers and published in April, 1995 and JP-A-2007-27939. Also, as another system, a two-channel SS system microphone array may be listed, which is described in JP-A-2004-289762.

A description is given of an example of the delay-and-sum type microphone array composed of two microphones with reference to FIG. 17. FIG. 17 is a configurational view showing the delay-and-sum type microphone array. Microphones 121 and 122 are disposed to be apart from each other at interval D. It is assumed that sound waves arrive at the microphones 121 and 122 at an angle θ from a distant place. In this case, the distance 8 over which a sound wave arrived at the microphone 121 propagates until it reaches the microphone 122 may be expressed by δ=D sin θ using the interval D between the microphones and the arrival angle θ. Therefore, the delay time τ from the sound wave having reached the microphone 121 to reaching the microphone 122 becomes τ=D sin θ/c, wherein c is the acoustic velocity.

Based on the above description, the output signal of the microphone 121 is delayed by delay devices 123 and 124 by D sin θ/c with respect to the microphone 122, the phases of the signals are adjusted, and the output signals are added by an adder 125, whereby a directivity having a beam (a direction of especially high sensitivity) in the direction θ can be formed for the output signal 126 of the adder 125. Therefore, if the beam is turned to the direction in which the target sound comes, it is possible to suppress noise and to intensify the target sound. Also, although the interval D between the microphones is required to be equal to or less than one half (½) the wavelength in the upper limit frequency of input sound waves, the sensitivity of the entire microphone array will be lowered if the interval D between the microphones is too small.

FIG. 18A shows a directional characteristic of the output signal 126 of the adder 125. In FIG. 18A, the direction θ of the target sound is set in the front side direction (angle 0°) of a plurality of microphones. As shown in FIG. 18A, where the number of the microphones is two, the difference in sensitivity between the direction θ (angle 0°) and the direction of ±90° (the right angle) from θ is only two to three dB, and a sharp beam cannot be formed. Therefore, the effect to intensify the target sound is hardly obtained. In order for the output signal 126 to form a beam of a narrow directivity, it is necessary that the microphones are arranged with the number thereof increased to, for example, four to eight, the phases of the output signal are arranged by the delay device, and the output signals are added. Accordingly, since the scale of the microphone array and the cost of the components are increased, it is difficult to mount such a microphone array in a small-sized communication terminal for general use such as a mobile phone.

On the other hand, in the delay-and-sum type microphone array shown in FIG. 17, such a system has been known in which signals at one side are subtracted from those at the other side by a subtractor 127. Such a configuration is called a delay-and-subtraction type microphone array. FIG. 18B shows a directional characteristic of an output signal 128 of the subtractor 127. As shown in FIG. 18B, where the delay-and-subtraction type microphone array is used, a directivity having a sharp null (a direction of low sensitivity) is formed in the direction θ in the output signal 128 of the subtractor 127 even if the number of microphones is two. Therefore, an effect to suppress noise can be obtained by setting the null direction in the noise arriving direction. However, the null formed by the output signal 128 is limited to one direction, and the null cannot be formed in a plurality of directions at one time. Therefore, noise coming from one direction can be suppressed, it is impossible to suppress noises coming from a plurality of directions at the same time.

The directional characteristic formed by the delay-and-sum type microphone array is determined by the delay time given to the delay devices 123 and 124. However, as a matter for automatically forming a null in the noise arriving direction, an adaptive-type microphone array has been known. FIG. 19 is a configurational view of an adaptive-filter-type microphone array, wherein a delay device 141 and an adaptive filter 142 are disposed instead of the delay devices 123 and 124 in FIG. 17. The delay time of the delay device 141 is fixed at approximately EA that is the maximum value in the delay time between two microphones. The adaptive filter 142 is updated from time to time so that the output of the adder 143 is minimized. Based on the above configuration, even if the noise arriving direction is not obvious or fluctuates in the adaptive-type microphone array, it becomes possible to continuously form a null in that direction. However, in this case, the direction of noise by which a null can be formed is limited to one direction at the same time, where the accuracy of the adaptive filter will be lowered under the situation where noises simultaneously arriving from a plurality of directions, that is, ambient noises exist.

Using FIG. 20 and FIG. 21A through FIG. 21C, a brief description is given of a microphone array of a two-channel SS system. FIG. 20 is a schematic view of a microphone array of a two-channel SS system. A target sound intensifier 153 for generating a beam in the direction of the target sound and a target sound attenuator 154 for forming a null in the direction of the target sound on the contrary are, respectively, connected to two microphones 151 and 152. A two-channel SS operator 155 outputs an output signal 156 having a sharp beam in the direction of the target sound by the two-channel SS operator 155 subtracting an output signal of the target sound attenuator 154, that is, the ambient sound signal from the output signal of the target sound intensifier 153 in the frequency domain.

FIGS. 21A and 21B are graphs of sensitivity characteristics obtained by the two-channel SS system, which show the sensitivity characteristics in a case where the target sound is in the front side direction, that is, the normal direction of two microphones. As shown by the chain line in FIG. 21A, a sharp beam is formed in the front side direction (angle 0°) in the output signal 156. However, a curved beam will be formed in this system, except in a case where the direction in which the beam is formed is aligned with the extension line of two microphones. In detail, the beam is formed along the curved surface on which a segment linking the microphones with the target sound is depicted by turning it with the extension line of the two microphones used as an axis. The state is shown in FIG. 211B and FIG. 21C. When the front side direction in which the beam is formed is 0°, a sharp beam by which the sensitivity in the front side direction becomes high is obtained with respect to angle A. However, no change is brought with respect to angle B, wherein it is understood that a planar beam is formed. Accordingly, where noise exists in the range of the planar beam, there is a fear that the ambient noise is not suppressed and is mixed with the target sound.

Generally in a portable communication apparatus and a speech recognition terminal, it is preferable that a sound pickup apparatus is disposed in a planar-shaped casing, and directivity having a beam in the front side direction thereof is formed. However, in order to achieve the same by a delay/addition-type microphone array, it is necessary to arrange a number of microphones. In this case, since the space and cost are increased, it becomes difficult to mount the microphones in a small-sized terminal. In addition, in the case of a delay-and-subtraction type microphone array using a subtractor in the delay/addition-type microphone array, although the null can be formed with a small number of microphones, the delay-and-subtraction type microphone array is not suitable for use for forming a beam in a desired direction. According to the microphone array of the two-channel SS system, which is described in JP-A-2004-289762, although a comparatively sharp beam can be formed with two microphones, the microphone array is still not suitable for the purpose of forming a beam only in the front side direction of the sound pickup apparatus as shown in FIG. 21B.

### SUMMARY

The present invention has been developed in view of such situations, and it is therefore an object of the invention to provide a sound pickup apparatus capable of forming a directivity having a sharp beam or a null in a specified direction by a microphone array composed of a small number of microphones, and a portable communication apparatus including the sound pickup apparatus, and an image pickup apparatus.

According to an aspect of the present invention, there is provided a sound pickup apparatus, including: a microphone array including at least three microphones, wherein a first pair of microphones in which two of the at least three microphones are aligned on a first axis, and a second pair of microphones in which two of the at least three microphones are aligned on a second axis; a first null signal generator which outputs a first null signal based on a differential output of the first pair of microphones, the first null signal having a directional characteristic in which a first null surface is defined by rotating a virtual line extending toward a direction of the lowest sensitivity around the first axis; a second null signal generator which outputs a second null signal, based on a differential output of the second pair of microphones, the second null signal having a directional characteristic in which a second null surface is defined by rotating a virtual line extending toward a direction of the lowest sensitivity around the second axis; and a combiner which generates a first target signal based on the first null signal and the second null signal, the first target signal having a directional characteristic in which the lowest sensitivity is formed in a direction to a line along which the first null surface meets the second null surface.

In addition, the sound pickup apparatus may further include a frequency domain subtractor which is adapted to perform subtraction in frequency domain of the first target signal from a signal output from one of the at least three microphones to output a second target signal.

According to the above configurations, since a beam (a direction of especially high sensitivity) or a null (a direction of especially low sensitivity) is formed only in the direction of a target sound by means of a microphone array including at least three microphones, which can be easily mounted in a small-sized terminal, it is possible to achieve a sound pickup apparatus having favorable performance to suppress ambient sounds.

### BRIEF DESCRIPTION OF THE DRAWINGS

In the accompanying drawings:

FIG. 1 is an appearance view of a communication apparatus according to Embodiment 1 of the present invention;

FIG. 2 is a block diagram of operations according to Embodiment 1 of the present invention;

FIG. 3 is a configurational view of components according to Embodiment 1 of the present invention;

FIG. 4 is a detailed block diagram of operations according to Embodiment 1 of the present invention;

FIG. 5A and FIG. 5B are schematic views of target sound direction according to Embodiment 1 of the present invention;

FIG. 6 shows a state where a three-dimensional coordinate system in FIG. 5 is superimposed on the communication apparatus;

FIG. 7A through FIG. 7F are sensitivity graphs of a null signal generator according to Embodiment 1 of the present invention;

FIG. 8A through FIG. 8C are graphs showing the operation description of a combiner according to Embodiment 1 of the present invention;

FIG. 9 is a flowchart of the operation description of a combiner according to Embodiment 1 of the present invention;

FIG. 10A and FIG. 10B are sensitivity graphs of a combiner according to Embodiment 1 of the present invention;

FIG. 11A and FIG. 11B are sensitivity graphs of a frequency domain subtractor according to Embodiment 1 of the present invention;

FIG. 12 is a block diagram of operations according to Embodiment 2 of the present invention;

FIG. 13 is a block diagram of operations according to Embodiment 3 of the present invention;

FIG. 14A and FIG. 14B are appearance views of an image pickup apparatus according to Embodiment 3 of the present invention;

FIG. 15A and FIG. 15B are views describing modified versions of the present invention;

FIG. 16 describes another modified version of the present invention;

FIG. 17 is a configurational view of a delay/addition-type microphone array according to a background art;

FIG. 18A and FIG. 18B are views of directional characteristic of a delay/addition-type microphone array according to the background art;

FIG. 19 is a configurational view of an adaptive-filter-type microphone array according to the background art;

FIG. 20 is a schematic configurational view of a two-channel SS system according to the background art; and

FIG. 21A through FIG. 21C are views of directional characteristic of a two-channel SS system according to the background art.

### DETAILED DESCRIPTION

An aspect of the present invention provides a sound pickup apparatus, including: a microphone array including at least three microphones, wherein a first pair of microphones in which two of the at least three microphones are aligned on a first axis, and a second pair of microphones in which two of the at least three microphones are aligned on a second axis; a first null signal generator which outputs a first null signal based on a differential output of the first pair of microphones, the first null signal having a directional characteristic in which a first null surface is defined by rotating a virtual line extending toward a direction of the lowest sensitivity around the first axis; a second null signal generator which outputs a second null signal, based on a differential output of the second pair of microphones, the second null signal having a directional characteristic in which a second null surface is defined by rotating a virtual line extending toward a direction of the lowest sensitivity around the second axis; and a combiner which generates a first target signal based on the first null signal and the second null signal, the first target signal having a directional characteristic in which the lowest sensitivity is formed in a direction to a line along which the first null surface meets the second null surface.

Therefore, it becomes possible to form a null (a direction of especially low sensitivity) only in the direction of the target sound by an easily mountable microphone array including at least three microphones, wherein a sound pickup apparatus having favorable performance to suppress noise in a specified direction can be composed.

The sound pickup apparatus may further include a frequency domain subtractor which is adapted to perform subtraction in frequency domain of the first target signal from a signal output from one of the at least three microphones to output a second target signal.

Therefore, it becomes possible to form a beam (a direction of especially high sensitivity) only in the direction of the target sound by an easily mountable microphone array including at least three microphones, wherein a sound pickup apparatus having favorable performance to suppress noise can be composed.

In the sound pickup apparatus, one microphone of the first pair of microphones may be the same as one microphone of the second pair of microphones.

Therefore, a sound pickup apparatus having favorable performance to suppress ambient sound by an easily mountable microphone array including at least three microphones, and the mounting cost can be reduced.

In the sound pickup apparatus, the first axis may intersect the second axis at right angles.

Therefore, it becomes possible to further accurately form a null (a direction of especially low sensitivity) or beam (a direction of especially high sensitivity) only in the direction of the target sound, wherein it is possible to compose a sound pickup apparatus having favorable performance to suppress ambient sounds.

The sound pickup apparatus may be configured in that the combiner includes: a first FFT section which transforms the first null signal into a first frequency signal having a first frequency characteristic related to first frequency bins; a second FFT section which transforms the second null signal into a second frequency signal having a second frequency characteristic related to second frequency bins; and an operator which generates the first target signal based on the first frequency signal related to the first frequency bins and the second frequency signal related to the first frequency bins.

Therefore, it becomes possible to estimate ambient sound signals upon changing the signals in the time domain to those in the frequency domain.

In the sound pickup apparatus, the operator may generate the first target signal by selecting each value of respective frequency bins of the first or second frequency signals, whichever is greater, in each frequency bin.

Therefore, since, in output signals of the two sets of null signal generators, the ambient sound signal existing in both the sets and the ambient signals existing only in either one of them are reflected in the output signals of the ambient sound signal estimator by the same weighting, it becomes possible to uniformly lower the side lobe (the sensitivity in the direction other than the direction of target sound) in the output signals of the frequency domain subtractor.

In the sound pickup apparatus, the operator adds each value of the respective frequency bins of the first frequency signal to each value of the respective frequency bins of the second frequency signal.

Therefore, it becomes possible to form a null (a direction of especially low sensitivity) in the direction of the target sound.

In the sound pickup apparatus, each of the first and second null signal generators may include a delay device and a subtractor to be implemented as a delay-and-subtraction type microphone array.

Therefore, a null is formed in an intended direction by the null signal generator applying a preset delay time to the delay device, wherein it becomes possible to form a beam in the intended direction in the output signals, of the frequency domain subtractor, obtained by using the same.

In the sound pickup apparatus, each of the first and second null signal generators may include a delay device and an adaptive filter to be implemented as an adaptive-type microphone array.

Therefore, where the null signal generator forms a null by automatically following the direction where the direction of the target sound is not obvious or fluctuates, it becomes possible to continuously form a beam having a high sensitivity in the direction of the target sound in the output signals, of the frequency domain subtractor, obtained by using the same.

The sound pickup apparatus may include an adjustor for adjusting individual differences in sensitivity of the at least three microphones to have the same sensitivity each other.

Therefore, such an effect can be brought about by which influences due to individual differences with respect to microphone sensitivity are reduced, and particularly, the accuracy is improved where a null signal is formed by a preset coefficient.

Further, there can be provided a portable communication apparatus including a display screen and the sound pickup apparatus disposed on a plane for arranging the display screen thereon.

In the portable communication apparatus, the direction of the line along which the first null surface may meet the second null surface is fixed in a front direction of the display screen.

Therefore, in a case of a video phone by which a user is capable of hand-free communication while looking at a display screen of a communication terminal, such an effect can be brought about by which the sound of a speaker located in the front side direction of the display screen can be clearly picked up.

In the portable communication apparatus, the direction of the line along which the first null surface may meet the second null surface automatically follows a direction of a target sound within a certain area centered around a front direction of the display screen.

Therefore, in a case of a video phone by which a user is capable of hand-free communication while looking at a display screen of a communication terminal, a beam is formed, following the direction even if the direction of the speaker changes centering around the front side direction of the display screen, wherein such an effect can be brought about by which the sound of the speaker can be clearly picked up and a favorable communication quality is obtained.

Further, there can be provided a portable communication apparatus including a key pad and the sound pickup apparatus disposed on a plane for arranging the key pad thereon.

Therefore, where a user carries out communications while operating keys, such an effect can be brought about by which the sound of the speaker located in the front side direction of the key pad can be clearly picked up.

The sound pickup apparatus may be configured in that the first null signal generator generates a third null signal based on signals output from the first pair of microphones, and the second null signal generator generates a fourth null signal based on signals output from the second pair of microphones, and the combiner directs, based on the third null signal and the fourth null signal, a direction of a line along which a third null surface of the third null signal meets a fourth null surface of the fourth null signal toward a direction of another target sound to be picked up.

Therefore, since sound waves arriving from a plurality of directions are individually separated and picked up where a user utters from a plurality of directions, the apparatus is effective for a sound conference apparatus and a speech recognition apparatus.

In the sound pickup apparatus, the frequency domain subtractor may be adapted to perform the subtraction based on an arbitrary subtraction ratio.

Therefore, it is possible to control the strength of the directivity of the sound pickup apparatus in accordance with the intention and situations of a user.

Further, there can be provided an image pickup apparatus including a camera for capturing an image and the sound pickup apparatus, wherein the direction of the line along which the first null surface meets the second null surface is set to a direction of the image to be captured, and wherein the subtraction ratio is determined in conjunction with a zoom ratio of the camera.

Therefore, such an effect can be brought about by which sound pickup limited to the sound sources existing in the image pickup range of a camera device is performed, and ambient sounds coming from outside the image pickup range can be suppressed.

Further, there can be provided an image pickup apparatus including a camera for capturing an image and the sound pickup apparatus, wherein a delay time of at least one of delay devices included in the first and second null signal generators is changed in response to a variation of a capturing direction of the camera so as to direct the line along which the first null surface meets the second null surface toward a direction of the image to be captured.

Therefore, even if the image capturing direction is changed by performing a pan and tilt operation of the image pickup apparatus, the beam direction can be followed to the direction, wherein such an effect can be brought about by which the image pickup screen and acoustic signals are continuously coincident with each other.

Hereinafter, a description is given of embodiments of the present invention with reference to the drawings.

### Embodiment 1

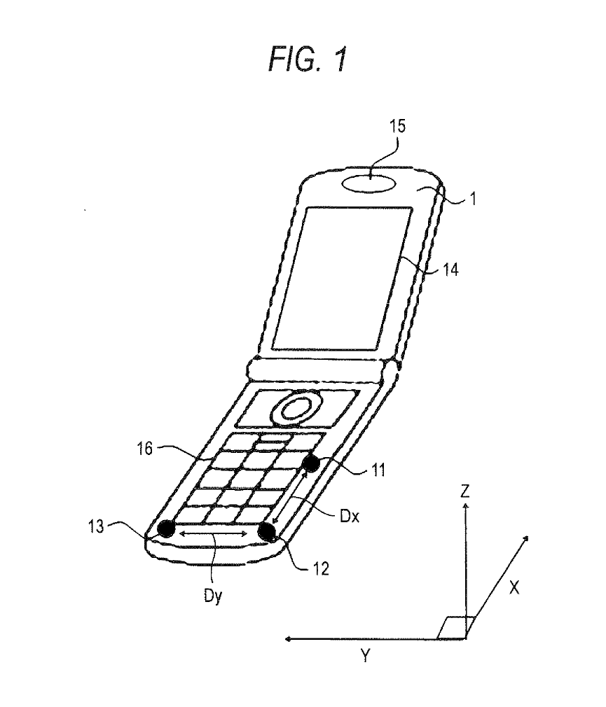

FIG. 1 is an appearance view showing a portable communication terminal 1 having a sound pickup apparatus according to Embodiment 1 mounted therein. The communication terminal 1 has a thin casing provided with a display screen 14, a speaker 15, a key pad 16, and three non-directional microphones 11, 12 and 13, etc. The microphones 11, 12 and 13 are disposed in the right-angle direction with the microphone 12 placed therebetween. It is assumed that the interval between the microphones 11 and 12 is Dx and the interval between the microphones 12 and 13 is Dy. That is, the respective microphones are disposed at the apexes of the right-angle triangle the short sides of which are Dx and Dy. Also, as the type of the microphones, it is desirable that a non-directional microphone is used in view of the cost. Alternatively, a microphone having directivity may be used.

A user of the terminal carries out a communication operation by using the key pad 16 and carries out sound input by the microphones while watching the display screen 14. In the case of such a use method, it is assumed that it is desirable that the sound pickup apparatus 10 has a beam (a direction of especially high sensitivity) in the direction of the z axis when it is assumed that the direction from the microphone 12 to the microphone 11 is x axis, the direction from the microphone 12 to the microphone 13 is y axis, and the direction perpendicular to the x-y plane is z axis in a three-dimensional orthogonal coordinate system.

As the sound pickup apparatus to achieve such directivity, a microphone array 20 composed of three microphones 11 through 13 is mounted in the communication terminal 1 in Embodiment 1. Here, although it is necessary to set the intervals Dx and Dy between the microphones to half the wavelength of the upper limit of the frequency of signal band in order not to produce spatial aliasing (folding noise), the sensitivity of the sound pickup apparatus 10 will be lowered if the interval is excessively small. For example, where the analog output signal of the microphone is converted to a digital signal of a sampling frequency 16 kHz, since the upper limit of the frequency is 8 kHz, the wavelength becomes 40 mm or slightly more, wherein it is favorable that the intervals Dx and Dy between the microphones are 20 mm or slightly less.

In addition, in order to make the sensitivities of the microphones 11 through 13 almost equivalent to each other, it is desirable that an adjustor for adjusting individual differences in the sensitivity of microphones is provided. A coefficient for adjustment is preset in the adjustor, for example, before shipment. Therefore, influences due to individual differences with respect to microphone sensitivity are reduced.

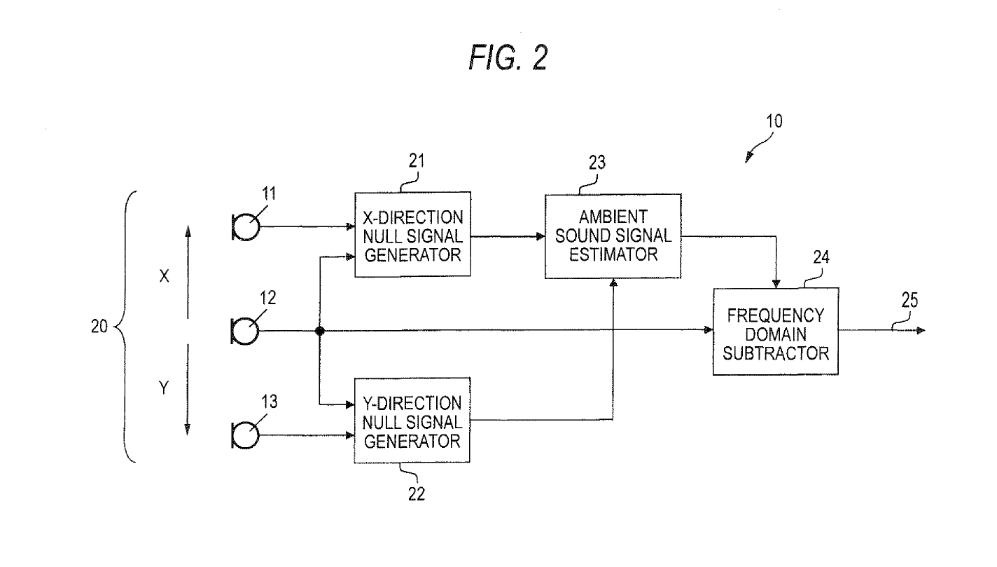

FIG. 2 is a schematic block diagram of operations of the sound pickup apparatus 10 according to Embodiment 1 of the present invention. The sound pickup apparatus 10 according to Embodiment 1 is provided with microphones 11, 12 and 13, an X-direction null signal generator 21, a Y-direction null signal generator 22, an ambient sound signal estimator 23, and a frequency domain subtractor 24, and outputs an output signal 25.

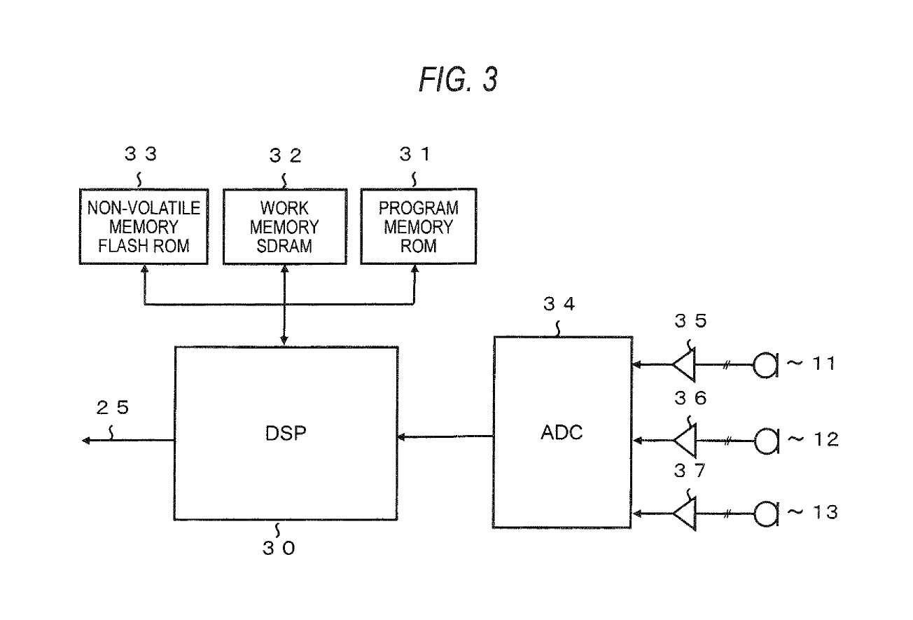

FIG. 3 is a hardware block diagram of the sound pickup apparatus 10 according to Embodiment 1 of the present invention. The sound pickup apparatus 10 includes a DSP (Digital Signal Processor) 30 for executing various types of signal processing, a program memory 31 for storing program software to perform various types of signal processing in the DSP 30, a work memory 32 for operation, which is required to execute various types of programs stored in the program memory 31 in the DSP 30, and a non-volatile memory 33 to record the processing results, etc., of the DSP 30. An ADC (Analog to Digital Converter) 34 is connected to the DSP 30. Three microphones 11 through 13 are connected to the ADC 34 via respective microphone drive circuits 35 through 37.

In the above configuration, analog signals that the microphones 11 through 13 output are subjected to signal processing in the DSP 30 after having been digitalized in the ADC 34. That is, respective processing of the X-direction null signal generator 21, the Y-direction null signal generator 22, the ambient sound signal estimator 23 and the frequency domain subtractor 24 in the operation block in FIG. 2 are executed by the DSP 30. The output signal 25 of the microphone array processing, which is obtained as a result thereof, is output from the DSP 30 or is utilized for other signal processing in the DSP 30.

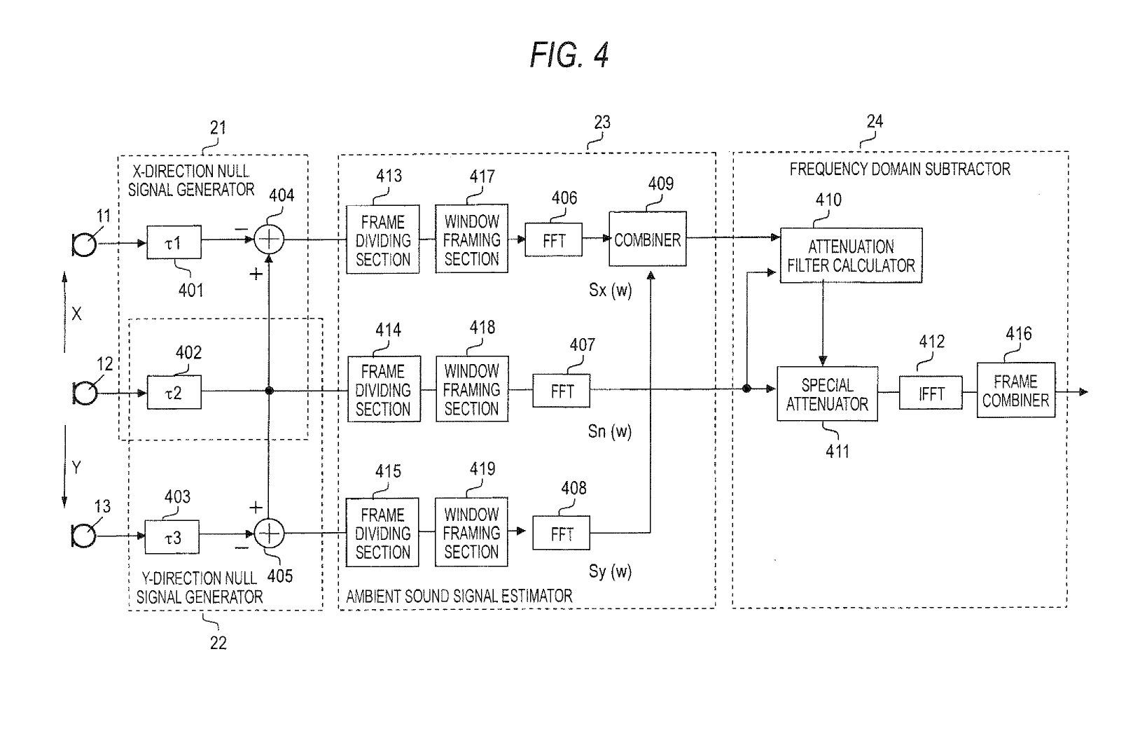

FIG. 4 shows an example of a detailed operation block, which composes respective operation blocks of signal processing in FIG. 2. The X-direction null signal generator 21 includes delay devices 401 and 402 connected to the microphones 11 and 12, which become a first pair of microphones, disposed in the X-direction in FIG. 1, and a subtractor 404. Similarly, the Y-direction null signal generator 22 includes delay devices 402 and 403 connected to the microphones 12 and 13, which become a second pair of microphones, disposed in the Y-direction in FIG. 1, and a subtractor 405. The X-direction and Y-direction null signal generators 21 and 22 having such a composition carry out processing called delay-and-subtraction type microphone array processing. Here, the delay device 402 connected to the microphone 12 is common to both of the X- and Y-direction null signal generators 21 and 22.

The ambient sound signal estimator 23 includes frame dividing sections 413 through 415, window framing sections 417 through 419, FFT sections 406 through 408, and a combiner 409. The frequency domain subtractor 24 includes an attenuation filter calculator 410, a spectral attenuator 411, an IFFT section 412, and a frame combiner 416.

Hereinafter, a detailed description is given of operation description of the sound pickup apparatus according to Embodiment 1 of the present invention.

First, a description is given of the operation of the X-direction and Y-direction null signal generators 21 and 22. Analog electric signals output upon sound waves reaching the microphones 11 through 13 are converted to digital signals by the ADC 34 and are input into the DSP 30. The X-direction null signal generator 21 and the Y-direction null signal generator 22 form directivity having a null (a direction of especially low sensitivity) in the direction of the target sound in the output signal on the planes (x-z plane and y-z plane) defined by the x axis and the z axis, and the y axis and the z axis in FIG. 1, respectively.

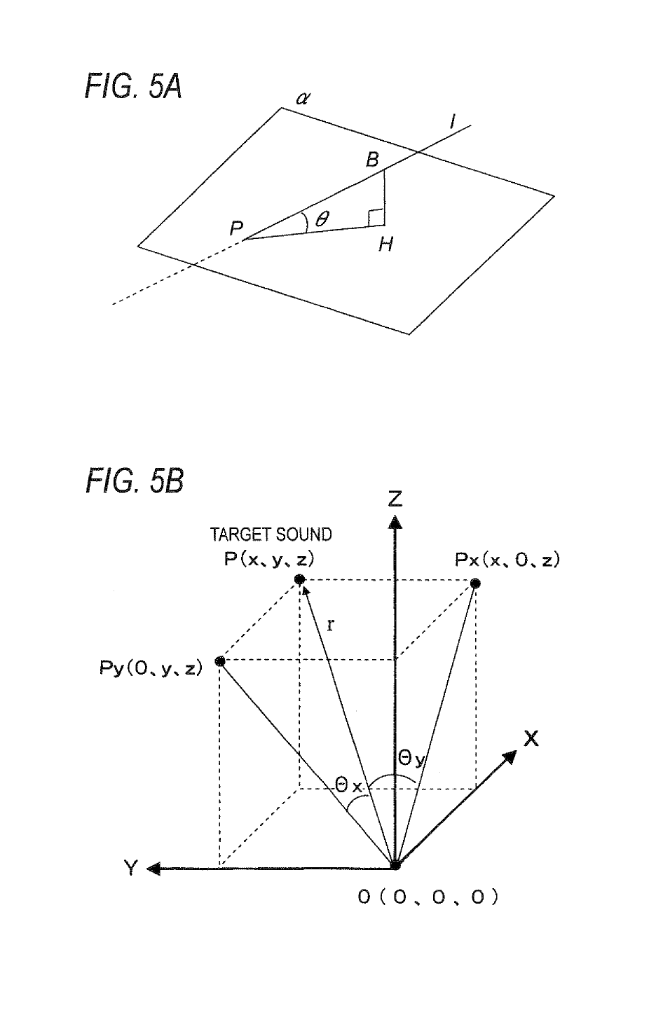

Here, the angle between a plane and a straight line is defined as follows. As shown in FIG. 5A, a case is taken into consideration where the plane a crosses the straight line I at the intersection point P. An optional point B on the straight line is taken, and a perpendicular line is drawn from the point B to the plane α. The point at which the perpendicular line crosses the plane is determined to be H. Here, it is assumed that ∠BPH is the angle θ between the plane α and the straight line I.

Using the delay-and-subtraction type microphone array shown in FIG. 4, a description is given of a detailed method for forming a null in the direction of the target sound by use of FIG. 5B. FIG. 5B transcribes a three-dimensional orthogonal coordinate system in FIG. 1. A case is taken into consideration where a single sound source (target sound) being an object of sound pickup such as a user of a terminal is positioned at point P in FIG. 5.

It is assumed that the coordinates of the point P are made into (x, y, z), and the straight line linking the origin O to the point P is a straight line r, and that the angle between the straight line r and the yz plane defined by the y axis and the z axis is made into θx. That is, ∠POPy becomes θx. The X-direction null signal generator 21 forms directivity having a null in the direction of θx. Therefore, the relationship between the delay times τ1 and τ2 given by the delay devices 401 and 402 in FIG. 4 is set as shown in [Mathematical Expression 1].

τ1−τ2=Dx·sin θx/c (c: acoustic velocity) [Mathematical Expression 1]

That is, since the sound wave of the sound source P located at the point P in FIG. 5B has a delay time of Dx·sin θx/c until the sound wave reaches the microphone 12 since it reaches the microphone 11, the phases of signals of the respective microphones 11 and 12 by the sound source P are made coincident with each other by giving a delay of Dx·sin θx/c to the signal of the microphone 11 with respect to the signal of the microphone 12. A null is formed in the direction of θx in the output signal of the subtractor 404 by subtracting the output signal of the delay device 401 from the output signal of the delay device 402 by means of the subtractor 404.

Similarly, with respect to the Y-direction null signal generator 22, the angle between the straight line r and the xz plane defined by the x axis and the z axis is made into θy, wherein ∠POPx becomes θy. The relationship between the delay times τ2 and τ3 given by the delay devices 402 and 403 in FIG. 4 is set as shown in [Mathematical Expression 2]. Therefore, a null is formed in the direction of θy in FIG. 5 in the output signal of the subtractor 405.

τ3−τ2=Dy·sin θy/c (c: acoustic velocity) [Mathematical Expression 2]

Here, since τ2 is common in the x direction of [Mathematical Expression 1] and the y direction of [Mathematical Expression 2], τ1 and τ3 may be obtained as the already known fixed value as in [Mathematical Expression 3]. If the value of τ2 is set to, for example, a value obtained by dividing either one of Dx or Dy, whichever is greater, by the acoustic velocity c, there is no case where τ1 and τ3 become negative in all the angle ranges that are obtainable by θx and θy.

τ1=τ2+Dx·sin θx/c

τ3=τ2+Dy·sin θy/c [Mathematical Expression 3]

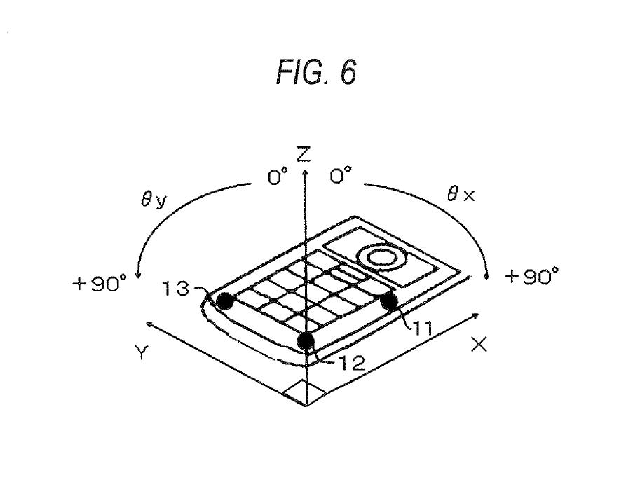

FIG. 6 shows a state where the three-dimensional orthogonal coordinate system in FIG. 5B is superimposed on the communication terminal 1. It is considered that there are many cases where the point P exists on the z axis, that is, in the front side direction of the microphone array 20 in the communication terminal 1. In this case, since signals arrive at the respective microphones almost at the same time, no delay is brought about, wherein the delay times τ1 through τ3 may be set to zero or may all be set to the same value. Accordingly, a sharp beam is formed in the z-axis direction, that is, in the front side direction of the terminal with respect to the output signal of the entire sound pickup apparatus.

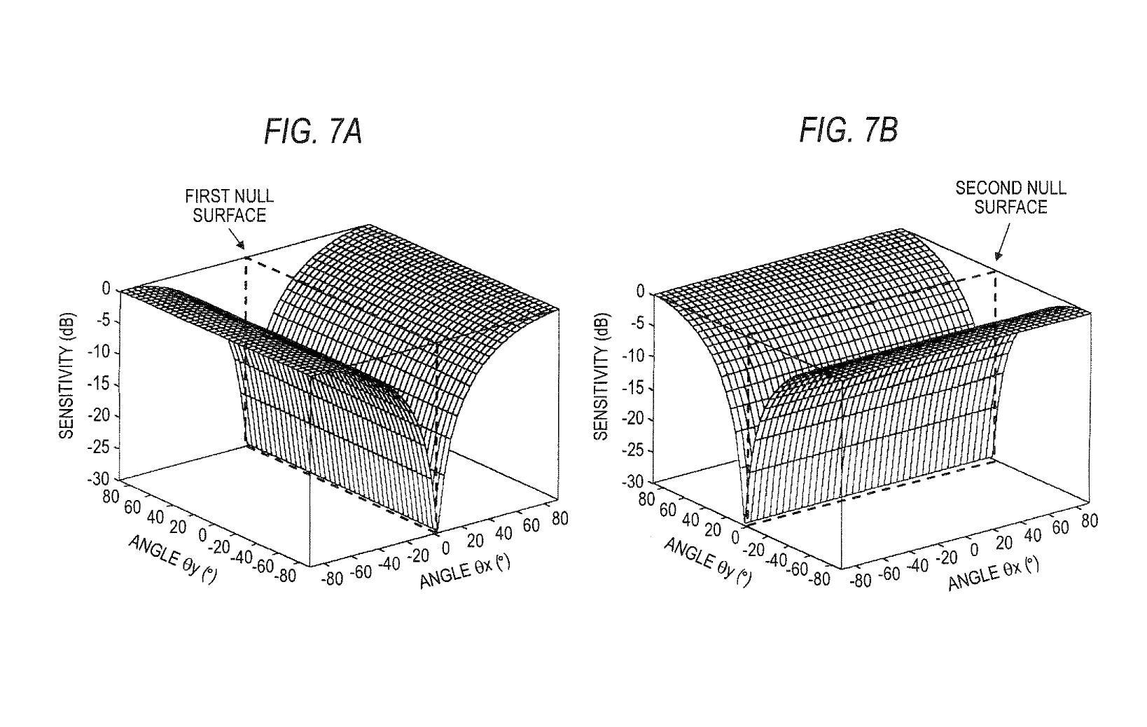

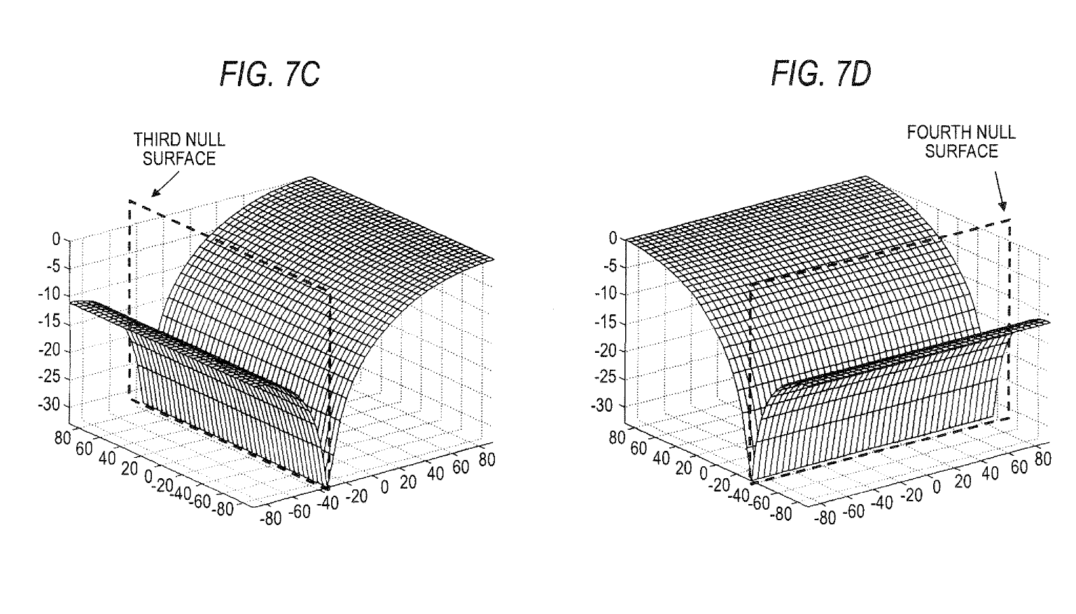

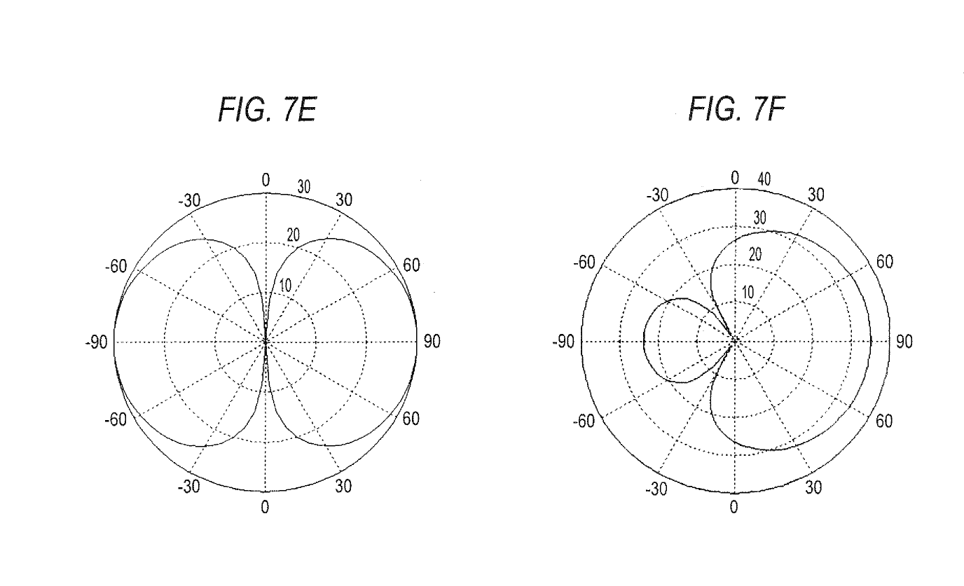

FIG. 7A and FIG. 7B show a sensitivity graph of respective output signals by the X-direction and Y-direction null signal generators 21 and 22 in the case where a null signal is formed in the z-axis direction. In FIG. 7A and FIG. 7B, the x axis expresses the angle from the front side of the microphone, the y axis expresses the angle from the upper side of the microphone on the axis orthogonal to the x axis, and the z axis expresses sensitivity. For example, when observing FIG. 7A that shows the sensitivity graph of the X-direction null signal generator 21, although a sharp null (a direction of low sensitivity) is formed in the direction of 0° (parallel to the yz plane) with respect to the angle θx, the sensitivity is uniform with respect to the angle θy. That is, since the direction of the angle θy seems to be the same angle from the two microphones 11 and 12, no null is formed. Similarly, for FIG. 7B showing the sensitivity graph of the Y-direction null signal generator 22, although a sharp null is formed in the direction of 0° (parallel to the xy plane) with respect to the angle θy, no null is formed with respect to θx that seems to be the same angle from the two microphones 12 and 13. In FIG. 7A, it can be regarded that a null is composed on the plane of θx=0. Also, in FIG. 7B, it can be regarded that a null is composed on the plane of θy=0. Here, the plane of θx=0 may be called the first null surface, and the plane of θy=0 may be called the second null surface. In the orthogonal coordinate system of the three-dimensional space, the first null surface is orthogonal to the straight line linking the microphone 11 with the microphone 12, and the second null surface is orthogonal to the straight line linking the microphone 12 with the microphone 13. In other words, where it is assumed that the straight line linking the microphone 11 with the microphone 12 is made into an abscissa, a polar pattern in which a null is generated at the angle of 0° orthogonal to the abscissa can be generated. By carrying out a combining process, which is described later, on the two null signals thus formed, a sharp null is formed in one direction.

In addition, if a difference is provided between the delay τ1 of the delay device 401 into which signals are input from the microphone 11 and the delay τ2 of the delay device 402 into which signals are input from the microphone 402, the direction of the null surface can be varied. The pattern is shown in FIG. 7C and FIG. 7D. This example shows a case where an angle of 35° is set by the difference between τ1 and τ2. A null surface of x=−35 is formed in FIG. 7C, and a null surface of y=−35 is formed in FIG. 7D. In the orthogonal coordinate system of the three-dimensional space, a surface obtained by rotating the straight line, which is inclined by 35° from the line perpendicular to the straight line linking the microphone 11 with the microphone 12, centering around the straight line linking the microphone 11 with the microphone 12, that is, a conical null surface is brought about. Similarly, in the case in FIG. 7D, in the orthogonal coordinate system of the three-dimensional space, a surface obtained by rotating the straight line, which is inclined by 35° from the line perpendicular to the straight line linking the microphone 12 with the microphone 13, centering around the straight line linking the microphone 12 with the microphone 13 is made into a conical null surface. In other words, as shown in FIG. 7F, if it is assumed that the straight line linking the microphone 11 with the microphone 12 is the abscissa, a polar pattern in which a null is generated at an angle of 35° from the straight line orthogonal to the abscissa can be generated.

In the above description, the ideal condition is that the microphone is spot-shaped, and the difference in the phase of sound waves reaching the microphone is accurately obtained in accordance with the angle of the sound source. Actually, however, the wider the area of the diaphragm of the microphone becomes, the more unclear the difference in phase becomes, wherein a shallow null having spread to some extent is brought about.

Next, a description is given of the operation description of the ambient sound signal estimator 23. Output signals of the X-direction null signal generator 21, the delay device 402 and the Y-direction null signal generator 22 are divided into frame signals having a predetermined time length and interval by the frame dividing sections 413 through 415, respectively. For example, the output signals are divided so that sampling is carried out at 8 kHz, the frame length is 128 points and the frame interval is 64 points. Therefore, the front half of the frame overlaps the latter half of the former frame, and the latter half of the frame overlaps the front half of the subsequent frame. This is to prevent the waveform from becoming discontinuous at the boundary of frames when the frames are combined and connected by the frame combiner 416 in the subsequent stage.

The window framing sections 417 through 419 carry out a window framing process on frame-by-frame divided signals so that frequency resolution accuracy required to perform an FFT process in a subsequent stage is obtained. A Hanning window as shown in, for example, the next [Mathematical Expression 4] may be used as the window function.

w(n)=0.5−cos {2πn/(L−1)} [Mathematical Expression 4]

Where L is the number of samples per frame, n expresses the sample position in a frame, that is, n=(0, 1, . . . , L−1) is established. In the window function, when the former frame is overlapped on the latter frame, the sums of the overlapped sections become equal to each other.

It is assumed that the sample row obtained by processing the output of the subtractor 404 by the window framing section 417 is x_{X-R,n}, where n is a sample number. It is assumed that the sample row obtained by processing the output of the subtractor 402 by the window framing section 418 is x_{R,n}. The sample row obtained by processing the output of the subtractor 405 by the window framing section 419 is X_{Y-R,n}.

The processes of the FFT sections 406, 407 and 408 are shown in the following [Mathematical Expression 5]. The output of the FFT section 406 is expressed by X_{X-R,p}, the output of the FFT section 407 is expressed by X_{R,p} and the output of the FFT section 408 is expressed by X_{Y-R,p}.

$${X}_{X - R , p} = {\sum }_{n} {x}_{X - R , n} exp ( - j2π \frac{p}{N} n ) \\ {X}_{R , p} = {\sum }_{n} {x}_{R , n} exp ( - j2π \frac{p}{N} n ) \\ {X}_{Y - R , p} = {\sum }_{n} {x}_{Y - R , n} exp ( - j2π \frac{p}{N} n ) \qquad [ Mathematical Expression 5 ]$$

where N is the total number of frequency bins, and p is a frequency bin number.

In the process of the combiner 409, it is assumed that the real part of X_{X-R,p} is [symbol] [X_{X-R,p}], the imaginary part thereof is ℑ[X_{X-R,p}], the real part of X_{R,p} is [symbol] [X_{R,p}], and the imaginary part thereof is ℑ[X_{R,p}], and the real part of the X_{Y-R,n} is [symbol] [X_{Y-R,p}] and the imaginary part thereof is ℑ[X_{Y-R,p}]. The real part [symbol] [X_{M,p}] of the selection-processed output signal X_{M,p} and the imaginary part ℑ[X_{M,p}] thereof are obtained by the next [Mathematical Expression 6].

$$[ Mathematical Expression 6 ]$$

$$[ {X}_{M , p} ] = \{ \begin{matrix} [ {X}_{X - R , p} ] & if { [ {X}_{X - R , p} ]}^{2} + { [ {X}_{X - R , p} ]}^{2} \geq { [ {X}_{Y - R , p} ]}^{2} + { [ {X}_{Y - R , p} ]}^{2} \\ [ {X}_{Y - R , p} ] & else\end{matrix} \\ [ {X}_{M , p} ] = \{ \begin{matrix} [ {X}_{X - R , p} ] & if { [ {X}_{X - R , p} ]}^{2} + { [ {X}_{X - R , p} ]}^{2} \geq { [ {X}_{Y - R , p} ]}^{2} + { [ {X}_{Y - R , p} ]}^{2} \\ [ {X}_{Y - R , p} ] & else\end{matrix}$$

Next, the frequency domain subtractor 24 carries out a subtraction process in the frequency domain using X_{R,p} and X_{M,p} with respect to all the frequencies p, and outputs a sample row x_{Z,n} of the time domain. Hereinafter, a detailed description is given of the operations of the frequency domain subtractor 24. First, in the attenuation filter calculator 410, Hₚ that is the ratio of X_{R,p} and X_{M,p} is calculated as in the [Mathematical Expression 7]. δ is a coefficient to prevent the denominator from becoming zero.

Hₚ=( [symbol] [X_{M,p}]²+ [symbol] [X_{M,p}]²)/( [symbol] [X_{R,p}]₂+ [symbol] [X_{R,p}]²+δ)

Hₚ=1 if H_{P}>1 [Mathematical Expression 7]

Next, the spectral attenuator 411 multiples the real part [symbol] [X_{R,p}] and the imaginary part [symbol] [X_{R,p}] of X_{R,p} by Hₚ as in the [Mathematical Expression 8], and the real part [symbol] [X_{Z,p}] of X_{Z,p} and the imaginary part [symbol] [X_{Z,p}] thereof are obtained. Based on the above, X_{M,p} is subtracted from X_{R,p} in the frequency domain.

[symbol]

[X_{Z,p}]=(1−Hₚ)× [symbol] [X_{R,p}]

[symbol]

[X_{Z,p}]=(1−H_{P})× [symbol] [X_{R,p}] [Mathematical Expression 8]

The IFFT section 412 performs an inverse FFT calculation of [Mathematical Expression 9] using X_{Z,p}, and obtains a sample row x_{Z,n} of the time domain.

$${x}_{Z , n} = \frac{1}{N} {\sum }_{p} {X}_{Z , p} exp ( j2π \frac{n}{N} p ) \qquad [ Mathematical Expression 9 ]$$

The frame combiner 416 combines continuous sound waveforms by adding the overlapped frames between the former and the latter frames one after another with respect to the frame-by-frame sample rows x_{Z,n}, and finishes combining.

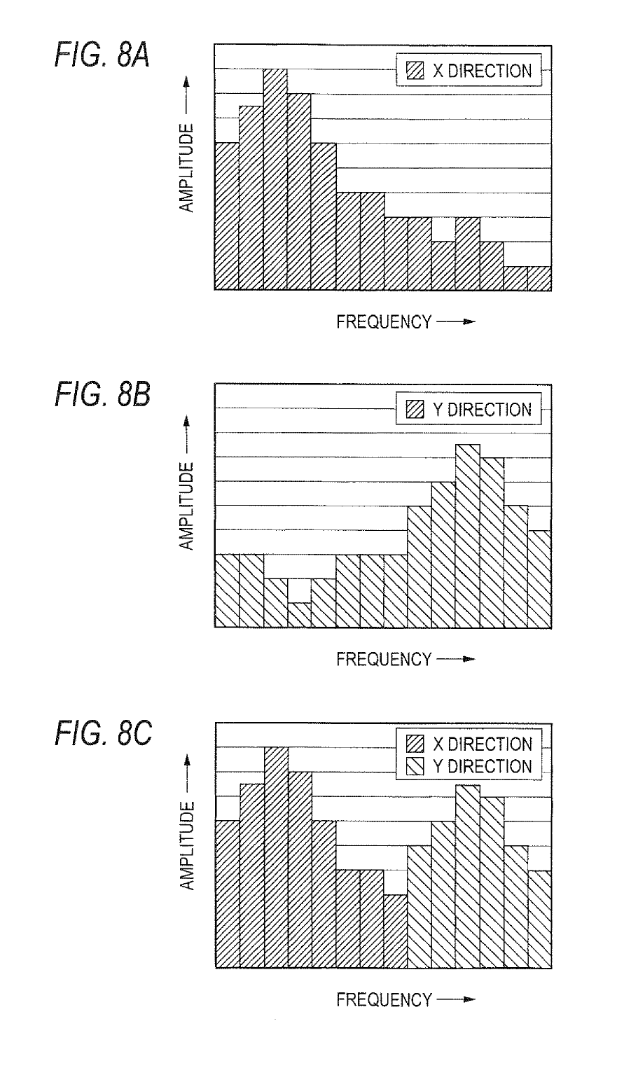

A description is given of a state where a selection process of such spectral signals is carried out, using FIG. 8A through FIG. 10A. FIG. 8A shows an example of amplitude spectrum |Sx(w)| of the X-direction null signal output by the FFT 406. Also, FIG. 8B shows an example of amplitude spectrum |Sy(w)| of the Y-direction null signal output by the FFT 408. The combiner 409 selects a greater amplitude value per frequency bin with respect to these two amplitude spectral signals, and combines a new amplitude spectral signal |Sn(w)|. FIG. 8C shows an example of the results. In FIG. 8C, values having a greater amplitude for respective frequency bins in FIG. 8A and FIG. 8B are selected and combined.

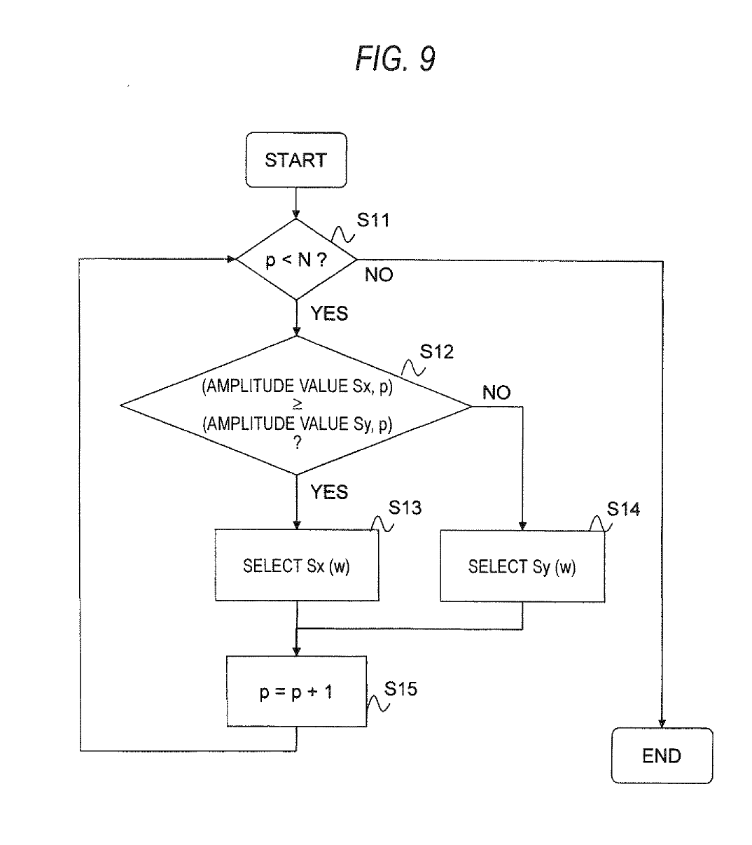

FIG. 9 shows a process for the combiner 409 to generate an amplitude spectral signal |Sn(w)|. In S11, the frequency bin number p is compared with the total number N of the frequency bins, and where p is smaller than N, the process advances to S12. When it is assumed that the amplitude values of the amplitude spectra |Sx(w)| and |Sy(w)| in the frequency bin number p are Sx,p and Sy,p, respectively, the value of Sx,p is compared with the value of Sy,p (S12). Where Sx,p is equal to or greater than Sy,p (S12: YES), |Sx(w)| is selected, and where Sx,p is less than Sy,p (S12: NO), |Sy(w)| is selected (S14). In S15, p is updated to the next number by adding 1 to the frequency pin number p. That is, amplitude values are selected for all the frequency bins. After all of the selection is over, the entire process is terminated (S11: NO).

Power spectra may be calculated instead of the amplitude spectra in the ambient sound signal estimator 23, and the frequency filter bank may be used without carrying out the FFT process.

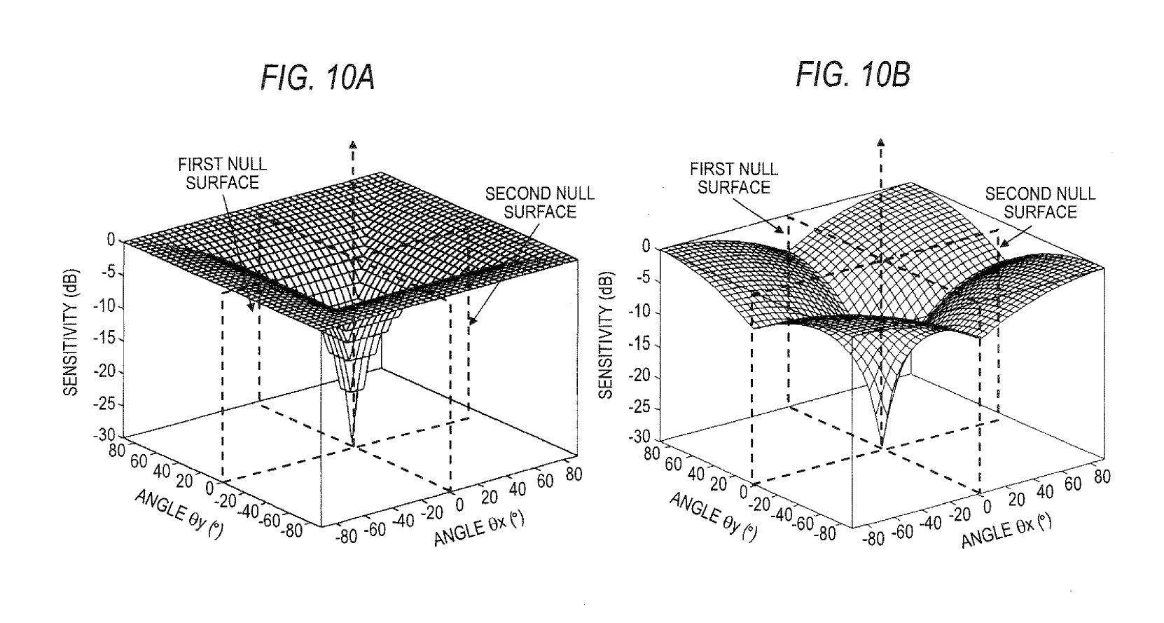

FIG. 10A shows a sensitivity graph of output signals of the combiner 409. Since the sensitivity graph in FIG. 10A shows a profile in which high sensitivity areas in FIG. 8A and FIG. 8B are combined with each other, the sensitivity is lowered toward only the intersection point of 0 degrees in the X axis and 0 degrees in the Y axis. A sharp null is formed in the straight line at which the first null surface in FIG. 7A and the second null surface in FIG. 7B cross each other, that is, in the direction of the Z axis.

As described above, since, in the combiner 409, the ambient sound signals existing in both output signals of the two sets of null signal generators and the ambient sound signal existing in only either one thereof are reflected onto the output signal of the ambient sound signal estimator at the same weighting, it becomes possible to uniformly lower the side lobe (the sensitivity in the direction other than the target sound) in the output signal of the frequency domain subtractor 24 described later.

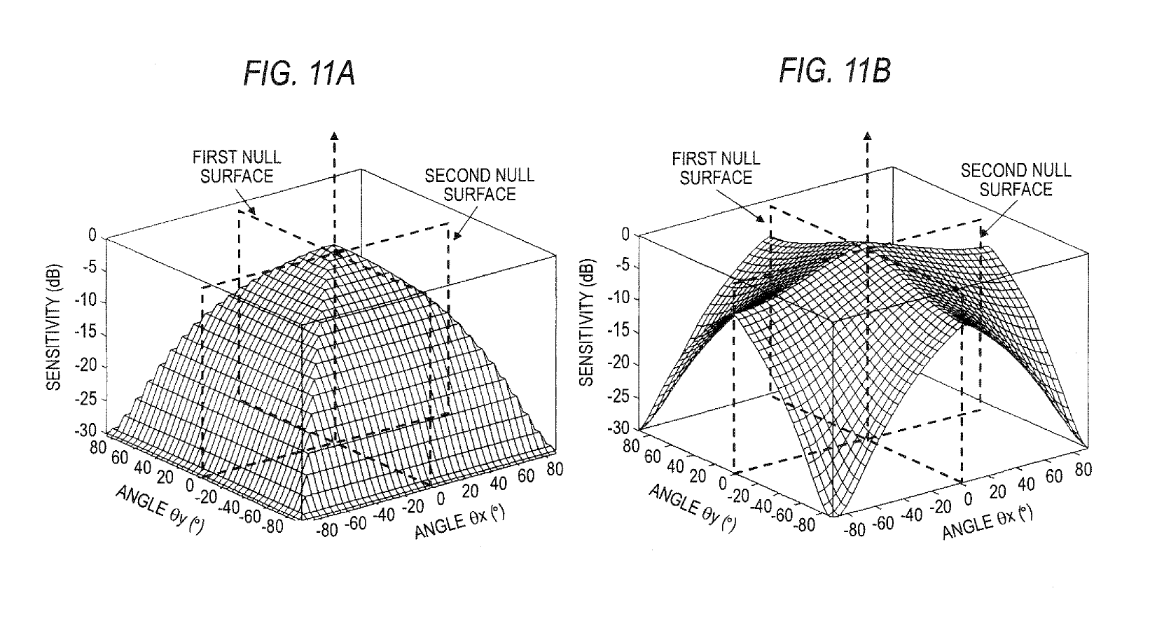

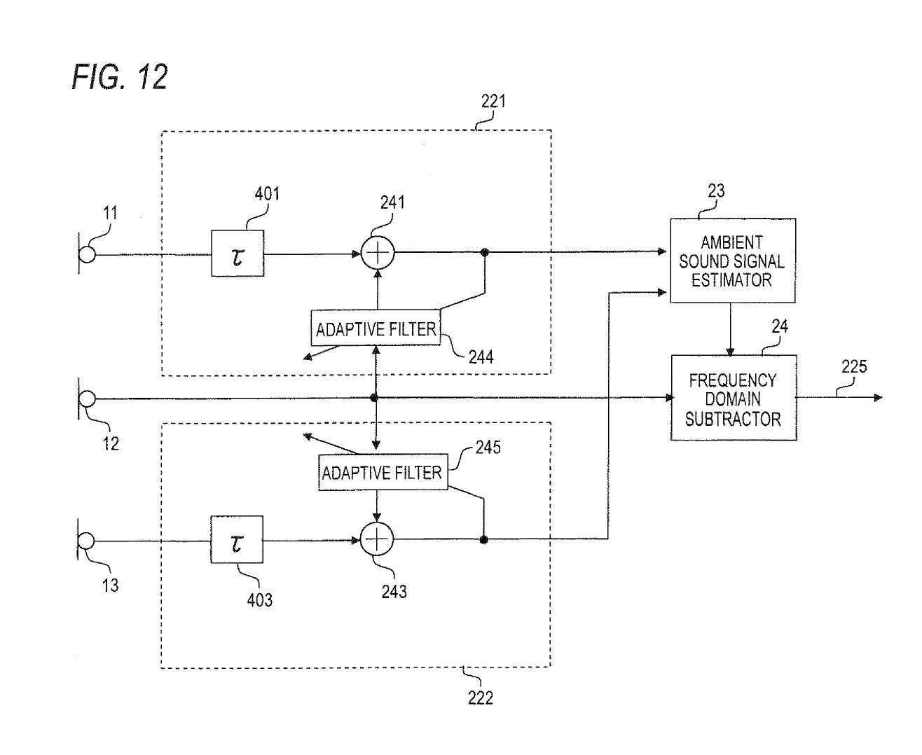

FIG. 11A shows a sensitivity graph of output signals by the frequency domain subtractor 24. Since the output of the FFT section 407 shows uniform sensitivity characteristics in all the angular directions of θx and θy as the characteristics of the non-directional microphone, in the sensitivity graph obtained as a result of having subtracted the spectral components of the ambient sound signal, a pattern in which the null direction in the sensitivity graph of FIG. 10A is inverted to the beam (a direction of high sensitivity) is obtained. A beam can be directed in the straight line at which the first null surface in FIG. 7A and the second null surface in FIG. 7B cross each other, that is, in the direction of the Z axis. Therefore, as shown in FIG. 11A, as a result of having subtracted the output signal of the combiner 409 in the frequency domain, a sensitivity graph of narrow directivity, in which the sensitivity is high in one direction of the target (that is, the direction of target sound) is obtained.

Further, in Embodiment 1, a description is given of a state where a selection process of spectra of the null signal in the X direction and the null signal in the Y direction is carried out. However, the present invention is not limited thereto. That is, a simple addition calculation may be adopted with respect to the spectral addition. FIG. 10B shows a sensitivity graph in which the spectra of null signals in the X direction and null signals in the Y direction are added. Also, the values in the drawing are the results of having performed normalization (the peak is adjusted to 0 dB). This is based on that, since there is a tendency for biasing in terms of frequency to exist depending on the differences in sound sources such as sounds and environmental noises in the input signals of a microphone, respective components of the amplitude spectra in FIGS. 8A through 8C can be approximated as corresponding to the ambient sounds in respective directions in the sensitivity graph in FIG. 10.

A null is formed along the direction of 0 degrees in the X axis and the Y axis, respectively, in FIG. 8A and FIG. 8B. Therefore, if both are combined, an area having low sensitivity is partially formed in the vicinity of 0 degrees in the X axis and the Y axis as shown in FIG. 10B, and although being inferior to the sensitivity graph in FIG. 10A, which is brought about by the selection process, a signal having a sharp null in the target direction is output. FIG. 11B shows the output result of the frequency domain subtractor 24 using the signal. Although there remains an area having high sensitivity for which the attenuation is 6 dB or less, along the x axis and y axis directions other than the z axis direction, a sensitivity graph of directivity, which has comparatively high sensitivity in the direction of the target sound, is brought about.

Since Embodiment 1 according to the present invention, which is achieved as described above, can form a sharp beam only in the target directions including the front side direction by a microphone array composed of a small number (three) of microphones, Embodiment 1 is suitable for the purpose of being incorporated in a small-sized apparatus as shown in FIG. 1 and executing sound pickup having few ambient sounds.

### Embodiment 2

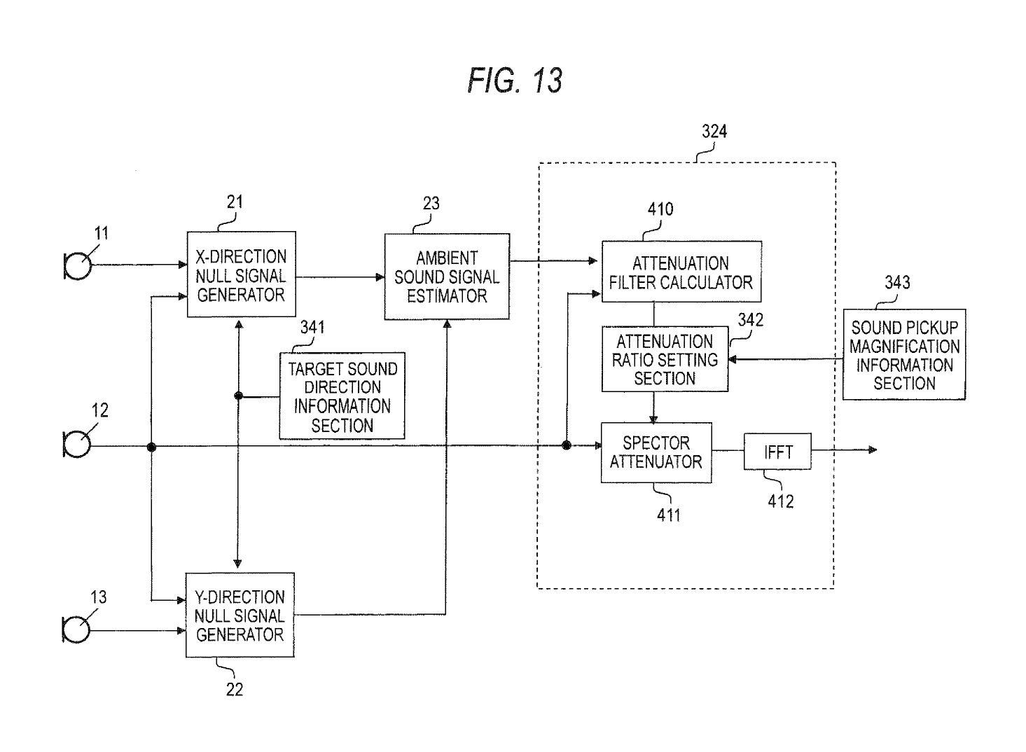

A description is given of Embodiment 2 according to the present invention by use of FIG. 12.

FIG. 12 is a block configurational view of a sound pickup apparatus according to Embodiment 2 of the present invention, and particularly shows block configuration of an X-direction null signal generator 221 and a Y-direction null signal generator 222.

In the present embodiment, two types of null signals are formed by an adaptive-filter-type microphone array, respectively. In the operation of the X-direction null signal generator 221, the signal of microphone 11 is delayed by the delay device 401, the adaptive filter 244 performs filter calculations using the signal of the microphone 12 as input, and the output signal of the adaptive filter 244 and the output signal of the delay device 401 are added to each other by the adder 241. In the adaptive filter 244, the filter coefficient is continuously updated so that the output signal of the adder 241 is minimized. Similarly, in the operation of the Y-direction null signal generator 222, the signal of the microphone 13 is delayed by the delay device 403, the adaptive filter 245 performs filter calculations using the signal of the microphone 12 as input, and the output signal of the adaptive filter 245 and the output signal of the delay device 403 are added to each other by the adder 243. And, in the adaptive filter 245, the filter coefficient is continuously updated so that the output signal of the adder 243 is minimized. The configurations of the ambient sound signal estimator 23 and the frequency domain subtractor 24, which come in the subsequent stage, are similar to those of Embodiment 1.

Such an adaptive filter can be achieved by an algorithm such as the LMS (Least Mean Square) method and the learning identification method. By applying a restriction condition to the learning process of the adaptive filter, the range to follow the target sound may be restricted, or distortion of the output signal can be reduced, and as such a method, a restriction learning method of Griffiths-Jim and AMNOR (Adaptive Microphone array for NOise Reduction) method have been known.

Based on the above configuration, the X-direction null signal generator 221 and the Y-direction null signal generator 222 automatically detect the direction of the target sound on the respective axes and can continuously form a null in the direction. Respective null signals output from the X-direction null signal generator 221 and the Y-direction null signal generator 222 are corrected by the combiner 409 of the ambient sound signal estimator 23. As a result, such an effect can be obtained by which a sharp beam is continuously formed only in the direction of the target sound in the output 225 of the frequency domain subtractor 24. In an actual use environment, although it is necessary to update the coefficient of the adaptive filter only in the case of the target sound by distinguishing the target sound from the ambient sound, such a method can be taken into consideration that distinguishes the sound and ambient sound from each other, paying attention to frequency bias between the sound and the ambient sound, wherein the output of the FFT section can be applied.

### Embodiment 3

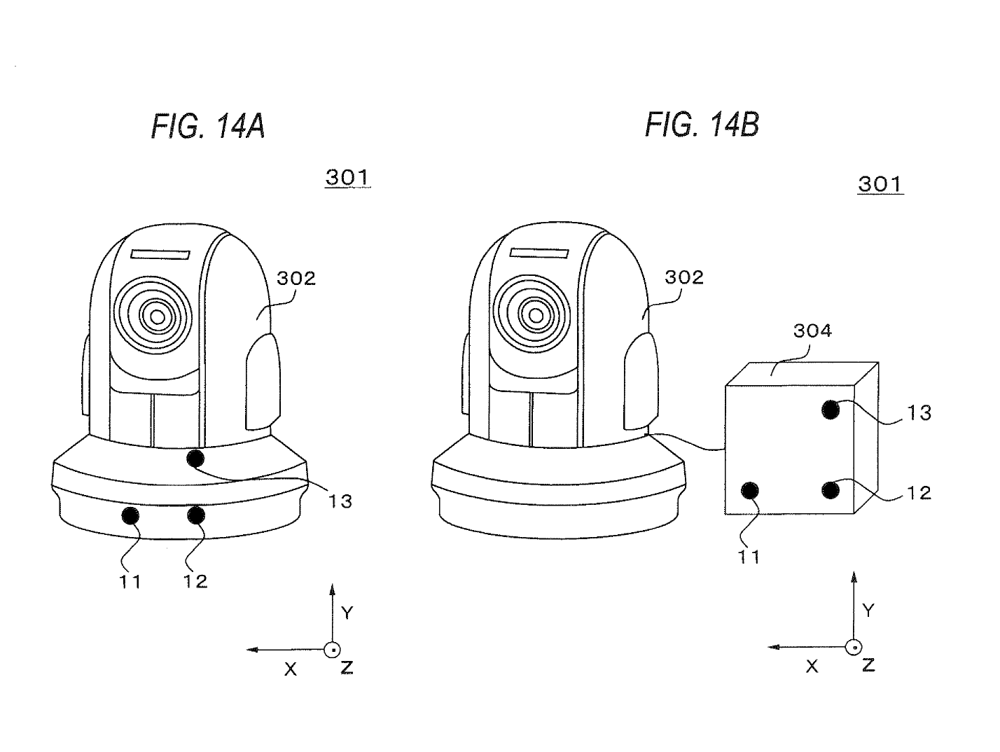

A description is given of Embodiment 3 according to the present invention with reference to FIG. 13 and FIG. 14A, 14B.

FIG. 13 is a block configurational view of a sound pickup apparatus according to Embodiment 3 of the present invention. A target sound direction information section 341, an attenuation ratio setting section 342 and a sound pickup magnification information section 343 are added to the configuration of Embodiment 1. The sound pickup apparatus according to the present embodiment is incorporated in an image pickup apparatus 301 such as a video camera, etc., as shown in FIG. 14A and FIG. 14B. The sections that overlap the components of Embodiment 1 are given the same reference numerals, and detailed description thereof is omitted.

FIG. 14A and FIG. 14B are perspective views of the image pickup apparatus 301 including three microphones 11 through 13. The image pickup apparatus 301 shown in FIG. 14A includes an image pickup section 302 and microphones 11 through 13 disposed in the image pickup apparatus 301. The image pickup apparatus 301 shown in FIG. 14B includes an image pickup section 302 and a microphone accommodation section 304 that is connected to the image pickup section 302 via a communication line and is separated from the image pickup section 302. The microphones 11 through 13 are incorporated in the microphone accommodation section 304. In the image pickup apparatus 301 in FIG. 14B, the components, other than the microphones 11 through 13, of the sound pickup apparatus 10 described in Embodiment 1, may be incorporated in either one of the image pickup section 302 or the microphone accommodation section 304, or may be incorporated in other devices. In addition, connection between the microphone accommodation section 304 and the image pickup section 302 may be implemented by wireless communications instead of a communication line.

The target sound direction information section 341 shown in FIG. 13 acquires information on the image capturing direction from the image pickup apparatus 301, and determines the target direction for sound pickup (that is, the direction of target sound) based on the information. The direction of the target sound is determined to be the center of the image capturing direction of the image pickup section 302. By reflecting the information on the target sound direction to the delay device in the X-direction and Y-direction null signal generators 21 and 22, the X-direction and Y-direction null signal generators 21 and 22 can form a null signal in the center direction in the image pickup screen. Further, a null and a beam are, respectively, formed in the target sound direction by the ambient sound signal estimator 23 and the frequency domain subtractor 324.

In detail, the microphones 11 through 13 are disposed in the form that the pan (horizontal) direction of the image pickup section 302 corresponds to the X axis, and the tilt (vertical) direction corresponds to the Y axis. In this case, the Z axis corresponds to the image capturing direction of a camera in the default state of the image pickup section 302 (that is, in a state where the camera is not panned or tilted).

When the image pickup section 302 is moved in the horizontal direction from the default state, the image capturing direction, that is, the target sound direction moves on the X axis. That is, θx becomes a greater value than 0°. Also, when the image pickup section 302 is moved in the vertical direction from the default state, the image capturing direction, that is, the target sound direction moves on the Y axis. That is, θy becomes a greater value than 0°.

The delay time that determines the direction of the directivity of sound pickup when θx and θy change and is given to the delay devices τ1 and τ3 in FIG. 4 is given, as in [Mathematical Expression 3] by referencing τ2. Therefore, a null can be formed to follow the image capturing direction in null signals output from the X-direction null signal generator 21 and the Y-direction null signal generator 22. As a result, it becomes possible that the null direction of the null signal output by the ambient sound signal estimator 23 is coincident with the image capturing direction, and the beam direction of the beam signal output by the frequency domain subtractor 324 is coincident with the image capturing direction.

Further, the sound pickup magnification information section 343 acquires information on the zoom ratio of image pickup from the image pickup apparatus 301, and sets the degree of the level by which the ambient sound signals are subtracted in the attenuation ratio setting section 342, wherein the level of directivity of the sound pickup apparatus is changed over. In detail, as in [Mathematical Expression 10], it is possible to adjust the level of the directivity by multiplying the coefficient Hₚ of [Mathematical Expression 7] by an attenuation ratio α.

Hₚ′=α·Hₚ

0≦α≦1 [Mathematical Expression 10]

It is possible to adjust the level of directivity, for example, narrow directivity is obtained when the attenuation ratio α is near 1, non-directivity of the microphone 12 is obtained when the attenuation ratio α is near 0, and intermediate directivity therebetween is obtained when the attenuation ratio α is 0.5 or so. Therefore, it is possible to attempt to coincide the sound source existing in the range of the image pickup screen and the acoustic signals picked up, wherein an effect can be obtained by which ambient sounds are prevented from being mixed from outside the image pickup range.

Also, it is not necessary to provide both of the target sound direction information section 341 and a set of the attenuation ratio setting section 342 and the sound pickup magnification information section 343. The target sound direction information section 341 may be independently provided, or only the attenuation ratio setting section 342 and the sound pickup magnification information section 343 may be provided.

In addition, although the target sound direction was set to the center in the image capturing direction of the image pickup section 302, the target sound direction may be set to the direction based on the result obtained from a calculation using parameters preset in the target sound direction information section 341 with respect to the information on the acquired image capturing direction.

In the above, the embodiments of the present invention were described. However, the present invention is not limited to the above-described embodiments, and appropriate modifications and changes can be made without departing from the essence of the present invention. Further, materials, shapes, dimensions and forms of the constituent elements can be set arbitrarily and no limitation is placed thereon.

In the above-described embodiments, a sound pickup apparatus having favorable performance to suppress ambient sounds has been achieved by forming a beam (the point of especially high sensitivity) in the target sound direction. However, with the present invention, it is possible to apply the present invention to suppress the sound only in a specified direction by using, for example, an output signal (that is, a null signal having a null (the point of especially low sensitivity) in the target sound direction as shown in FIG. 10A and FIG. 10B) of the combiner 409 of FIG. 4.

In the above-described embodiments, three microphones 11 through 13 were disposed at right angles centering around the microphone 12. However, the arrangement of the microphones is not limited to the right angle. That is, the relationship may be acceptable in which the axes on which the first pair of the microphones 11 and 12 and the second pair of the microphones 12 and 13 are disposed cross each other so that the microphones 11 and 12 composing the first pair and the microphones 12 and 13 composing the second pair can form a null in different directions. In this case, although the accuracy of a beam of the output signal of the frequency domain subtractor 24 is lowered more or less, the degree of freedom to dispose the microphones is increased. Accordingly, the configuration is effective for a case where there is a restriction in arrangement of microphones as in a small-sized terminal such as a mobile phone.

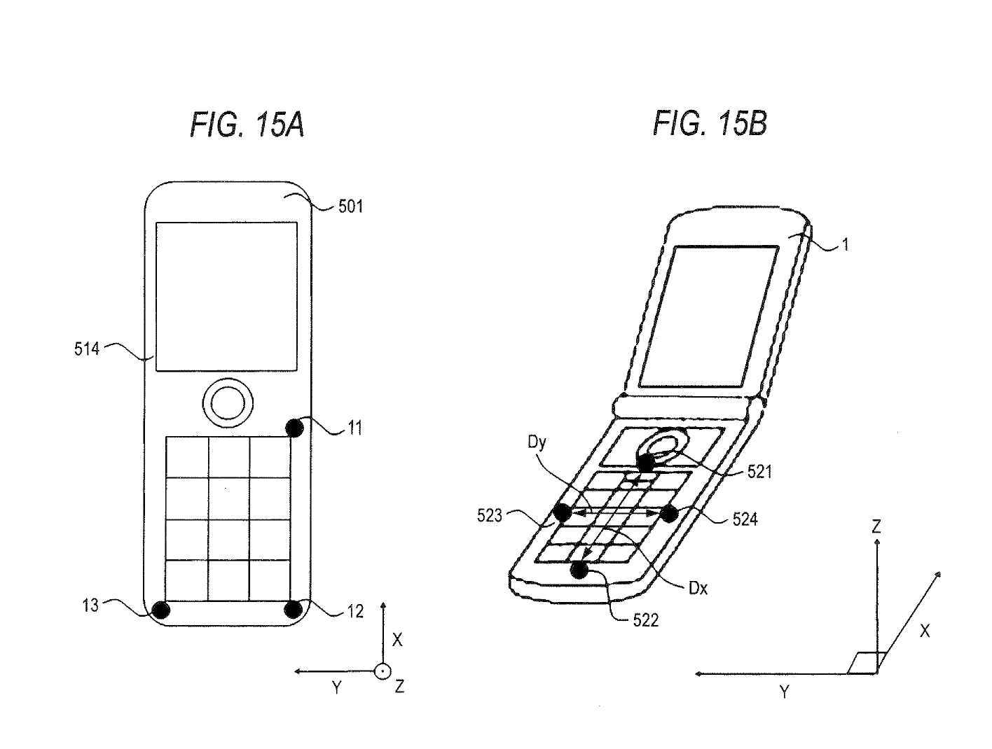

In Embodiment 1 described above, a folding-type communication terminal 1 was assumed. However, as in FIG. 15A, it may be considered that the sound pickup apparatus is incorporated in, for example, a straight-type portable terminal 501. In this case, since the display screen 514 of the portable terminal 501 and the microphones 11 through 13 are disposed on the same plane, it becomes possible to form a beam in the direction of an image being picked up while displaying an image being picked up by means of, for example, a camera on the display screen 514, wherein convenience of the user can be improved. In addition, in the case of a communication terminal 1 in FIG. 1, the microphones 11 through 13 may be disposed on the same plane as that of the display screen 14.

In the above-described embodiments, the microphone 12 of the three microphones 11 through 13 is used as a common microphone to form a null in the X direction and the Y direction. However, the common microphone to form a null in the X direction and the Y direction may not be prepared, such a configuration may be adopted in which a null is formed separately in the X direction and the Y direction. That is, as shown in FIG. 15B, four microphones 521 through 524 are prepared, wherein the microphones 521 and 522 that become the first pair are used to form a null in the X direction with the interval Dx therebetween, and the microphones 523 and 524 that become the second pair are used to form a null in the Y direction with the interval Dy therebetween. Even in this case, as in Embodiment 1, a signal having a sharp beam (or a null) formed in the target sound direction can be generated. Further, any one of the four microphones 521 through 524 or another microphone prepared may be used in the frequency domain subtractor 24 as a microphone showing non-directivity, which is used to generate a beam signal from a null signal in the target sound direction and shows a uniform sensitivity characteristic in all the angular directions.

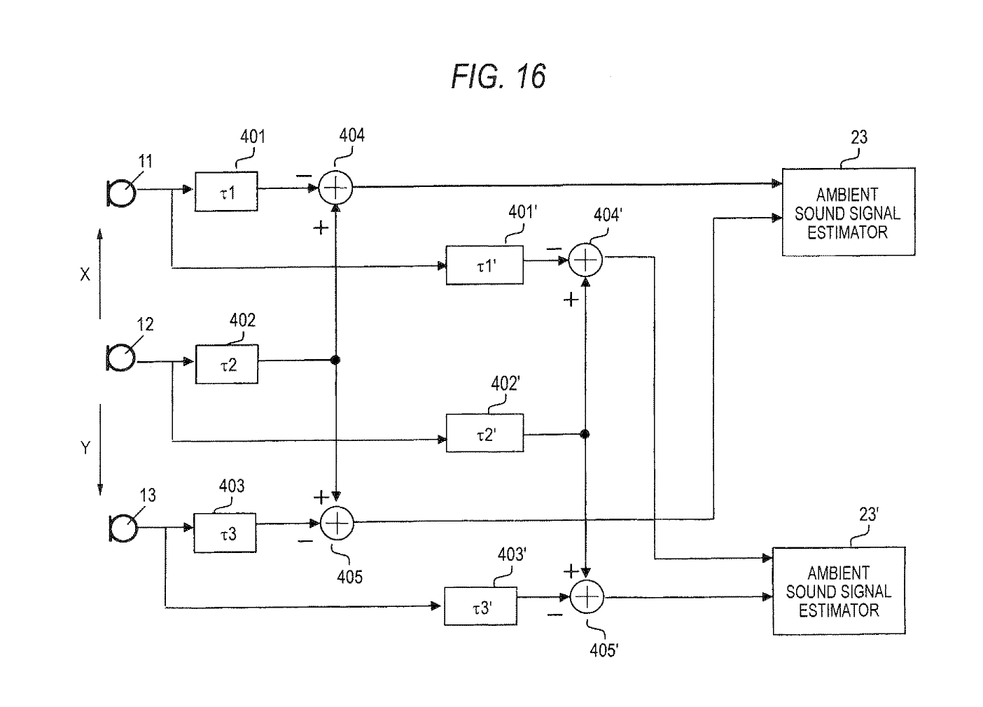

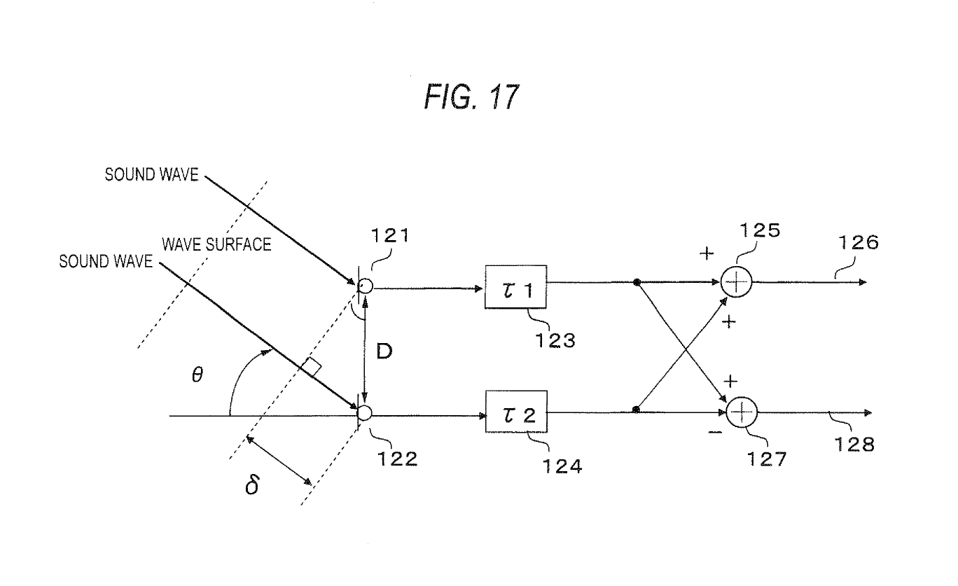

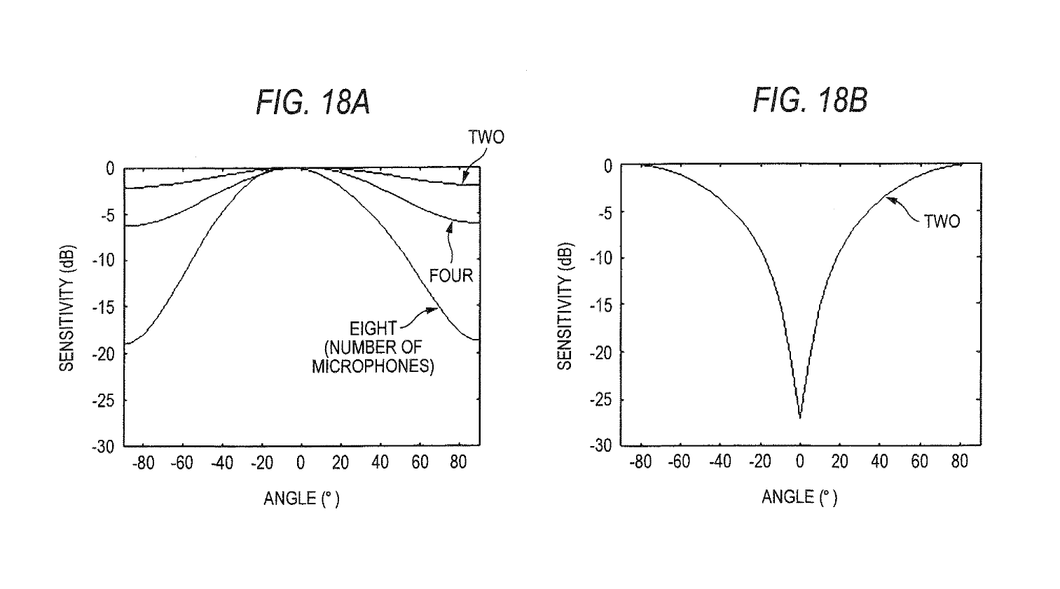

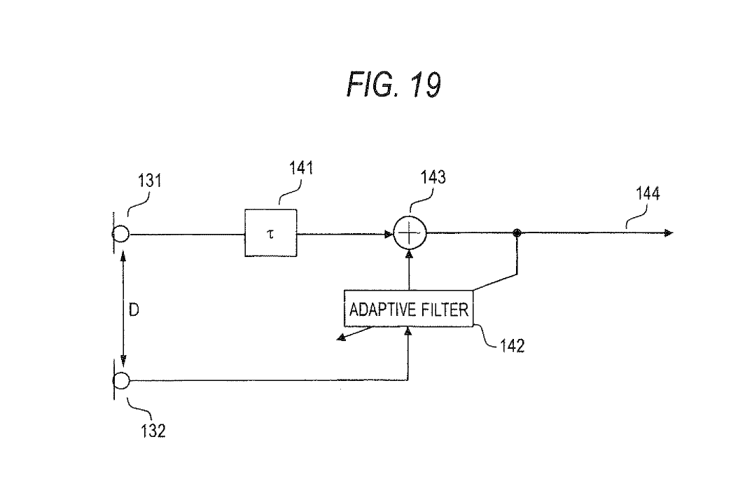

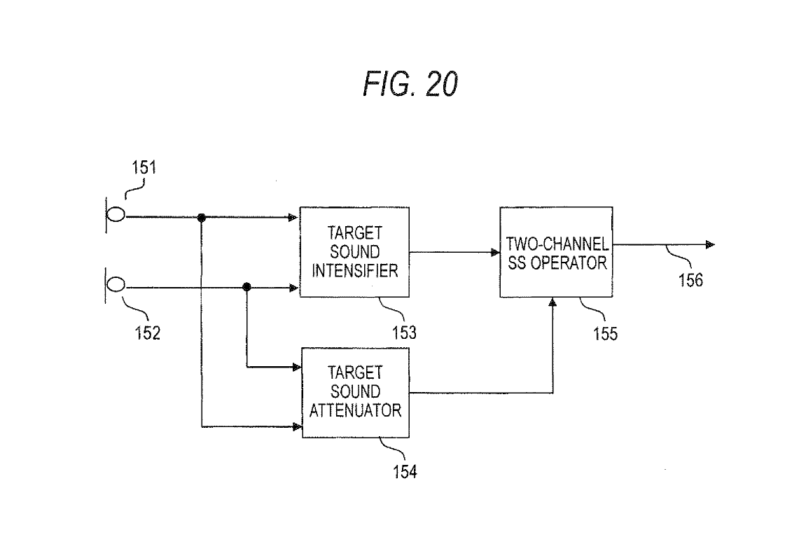

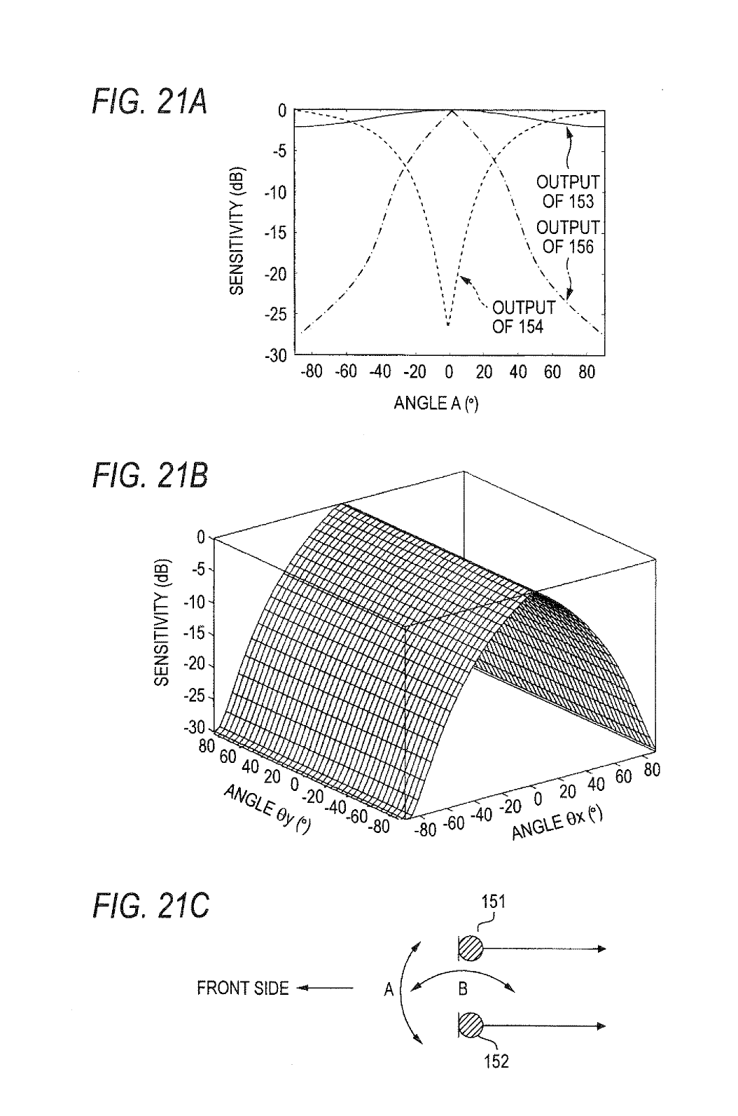

In the above-described embodiment, a beam is formed in one certain target sound direction. However, since the direction of the target sound is determined by setting the delay time as shown in [Mathematical Expression 3], a beam may be formed in a plurality of directions. FIG. 16 shows a block diagram to form a null in two target sound directions. Signals picked up by the microphone 11 are separated into the delay devices 401 and 401′, and the delay times τ1 and τ1′ are set for the respective separated signals. With respect to the signals picked up by the microphones 12 and 13, the delay times τ2, τ2′, τ3, τ3′ are set by the delay devices 402, 402′ and the delay devices 403, 403′ as well. Therefore, it is possible to form a null in a plurality of directions by sending signals, which have passed the delay devices 401 through 403 and the adders 404, 405, to the ambient sound signal estimator 23 and sending signals, which have passed the delay devices 401′ through 403′ and the adders 404′, 405′, to the ambient sound signal estimator 23′. By subtracting the frequency domains using the plurality of null signals, a plurality of signals having a beam formed in different directions can be output.

According to the present invention, since a beam or a null can be formed only in the target sound direction by a microphone array composed of at least three microphones, it is possible to achieve a sound pick apparatus that can be easily mounted in a small-sized terminal, and has favorable performance to suppress ambient sounds.

What is claimed is:

1. A sound pickup apparatus, comprising:
a microphone array including at least three microphones, wherein a first pair of microphones in which two of the at least three microphones are aligned on a first axis, and a second pair of microphones in which two of the at least three microphones are aligned on a second axis;
a first null signal generator which outputs a first null signal based on a differential output of the first pair of microphones, the first null signal having a directional characteristic in which a first null surface is defined by rotating a virtual line extending toward a direction of the lowest sensitivity around the first axis;
a second null signal generator which outputs a second null signal, based on a differential output of the second pair of microphones, the second null signal having a directional characteristic in which a second null surface is defined by rotating a virtual line extending toward a direction of the lowest sensitivity around the second axis; and
a combiner which generates a first target signal based on the first null signal and the second null signal, the first target signal having a directional characteristic in which the lowest sensitivity is formed in a direction to a line along which the first null surface meets the second null surface.

2. The sound pickup apparatus according to claim 1, further comprising a frequency domain subtractor which is adapted to perform subtraction in frequency domain of the first target signal from a signal output from one of the at least three microphones to output a second target signal.

3. The sound pickup apparatus according to claim 1, wherein one microphone of the first pair of microphones is the same as one microphone of the second pair of microphones.

4. The sound pickup apparatus according to claim 1, wherein the first axis intersects the second axis at right angles.

5. The sound pickup apparatus according to claim 1, wherein the combiner comprises:
a first FFT section which transforms the first null signal into a first frequency signal having a first frequency characteristic related to first frequency bins;
a second FFT section which transforms the second null signal into a second frequency signal having a second frequency characteristic related to second frequency bins; and
an operator which generates the first target signal based on the first frequency signal related to the first frequency bins and the second frequency signal related to the first frequency bins.

6. The sound pickup apparatus according to claim 5, wherein the operator generates the first target signal by selecting each value of respective frequency bins of the first or second frequency signals, whichever is greater, in each frequency bin.

7. The sound pickup apparatus according to claim 5, wherein the operator adds each value of the respective frequency bins of the first frequency signal to each value of the respective frequency bins of the second frequency signal.

8. The sound pickup apparatus according to claim 1, wherein each of the first and second null signal generators comprises a delay device and a subtractor to be implemented as a delay-and-subtraction type microphone array.

9. The sound pickup apparatus according to claim 1, wherein each of the first and second null signal generators comprises a delay device and an adaptive filter to be implemented as an adaptive-type microphone array.

10. The sound pickup apparatus according to claim 1, comprising an adjustor for adjusting individual differences in sensitivity of the at least three microphones to have the same sensitivity each other.

11. A portable communication apparatus including a display screen and the sound pickup apparatus as set forth in claim 1, wherein the sound pickup apparatus is disposed on a plane for arranging the display screen thereon.

12. The portable communication apparatus according to claim 11, wherein the direction of the line along which the first null surface meets the second null surface is fixed in a front direction of the display screen.

13. The portable communication apparatus according to claim 11, wherein the direction of the line along which the first null surface meets the second null surface automatically follows a direction of a target sound within a certain area centered around a front direction of the display screen.

14. A portable communication apparatus including a key pad and the sound pickup apparatus as set forth in claim 1, wherein the sound pickup apparatus is disposed on a plane for arranging the key pad thereon.

15. The sound pickup apparatus according to claim 1, wherein the first null signal generator generates a third null signal based on signals output from the first pair of microphones, and the second null signal generator generates a fourth null signal based on signals output from the second pair of microphones, and
wherein the combiner directs, based on the third null signal and the fourth null signal, a direction of a line along which a third null surface of the third null signal meets a fourth null surface of the fourth null signal toward a direction of another target sound to be picked up.

16. The sound pickup apparatus according to claim 2, wherein the frequency domain subtractor is adapted to perform the subtraction based on an arbitrary subtraction ratio.

17. An image pickup apparatus including a camera for capturing an image and the sound pickup apparatus as set forth in claim 16, wherein the direction of the line along which the first null surface meets the second null surface is set to a direction of the image to be captured, and
wherein the subtraction ratio is determined in conjunction with a zoom ratio of the camera.

18. An image pickup apparatus including a camera for capturing an image and the sound pickup apparatus as set forth in claim 2, wherein a delay time of at least one of delay devices included in the first and second null signal generators is changed in response to a variation of a capturing direction of the camera so as to direct the line along which the first null surface meets the second null surface toward a direction of the image to be captured.
